(19) United States
(12) Patent Application Publication
(10) Pub. No.: US 2007/0228217 A1
(43) Pub. Date: Oct. 4, 2007

(54) Window Frame for Aircraft

(75) Inventor: Jens Bold, Hamburg (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Airbus Deutschland GmbH, Hamburg (DE)

(21) Appl. No.: 11/597,350

(22) PCT Filed: May 24, 2005
(86) PCT No.: PCT/EP05/05608

§ 371 Date: Nov. 21, 2006

Related U.S. Application Data
(60) Provisional application No. 60/600,102, filed on Aug. 9, 2004.

(30) Foreign Application Priority Data
May 24, 2004 (DE) 10 2004 025 383.8

(51) Int. Cl. B64C 1/14

(52) U.S. Cl. 244/129.3

(57) ABSTRACT

With a window frame (1) for installation in the exterior shell (5) of an aircraft, which comprises at least one outer flange (2), an inner flange (3), and a vertical flange (4) arranged perpendicular to and between these flanges and in which on the inner (3) and vertical flanges (4), a window element (7, 8) to be held is attached, which is fixed in its position with a down holder (10) connected with the window frame (1), the downholder (10) comprises a fiber-reinforced synthetic resin material. The layer structure of the downholder corresponds to a quasi-isotropic plate and a semifinished part comprising web and thermoplastic material is made as a quasi-isotropic sheet material and this is transformed in a deep drawing process into the net shape of the downholder.

### REFERENCE TO RELATED APPLICATIONS

This application claims the benefit of the filing date of U.S. Provisional Patent Application No. 60/600,102 filed Aug. 9, 2004, the disclosure of which is hereby incorporated herein by reference and of the German Patent Application DE 10 2004 025 383 filed May 24, 2004, the disclosure of which is hereby incorporated herein by reference.

### FIELD OF THE INVENTION

The invention relates to a window frame for installation in the exterior shell of an aircraft and to a method of manufacturing a downholder.

### TECHNOLOGICAL BACKGROUND

In most of the aircraft made and in operation today, window frames made of aluminum are used, which comprise a part which is made by forging, truing and cupping. The component is organized into a total of three regions: an outer flange, an inner flange, and a vertical flange arranged perpendicular to and between these two flanges. The window frames are typically connected with two rows of rivets over the outer flange with the aircraft structure or with the exterior shell of the aircraft. A window element rests on the inner flange, which typically comprises two panes and a sealing arranged therebetween and which is fixed in its position via a downholder, also designated as a retainer, which is connected with the window frame.

### SUMMARY OF THE INVENTION

It may be an object of the present invention to provide a window frame, which makes possible a considerable weight savings compared to the window frames used today for this application. At the same time, the costs for making such a window frame should be as low as possible. In addition, from the invention, the simplest and most cost-effectively performed method for making such a window frame should be provided.

According to an exemplary embodiment, the window frame may comprise an outer flange, an inner flange, and a vertical flange arranged perpendicular to and between the inner and the outer flanges. The connection of the window frame to the aircraft structure may be realized by the outer flange. A window element abuts against at least one of the inner and outer flanges. The window element is fixed into its position via a downholder connected with the window frame.

According to an aspect of the present invention, the downholder comprises or consists of a fiber-reinforced synthetic resin material.

According to another aspect of the present invention, a method is provided, in which a semifinished part made from web and thermoplastic material is made as a quasi-isotropic sheet material and this is transformed in a deep drawing process in the net shape of the downholder.

By means of the use of the present invention of a downholder made from a fiber-reinforced synthetic resin material, weight savings of approximately 20 percent may be achieved, compared to the window frames made completely from aluminum that have been used up to now. In spite of this great weight savings potential, the costs for such a component, compared to a window frame made from an aluminum forged part, do not rise.

### SHORT DESCRIPTION OF THE DRAWINGS

Next, the invention will be described in greater detail with reference to one embodiment shown in the accompanying figures. In the figures:

FIG. 1 shows a window frame in perspective view;

FIG. 2 shows a detail section through the installation position of a window frame according to FIG. 1;

FIG. 3 shows a downholder in perspective view.

### DETAILED DESCRIPTION OF EXEMPLARY EMBODIMENTS

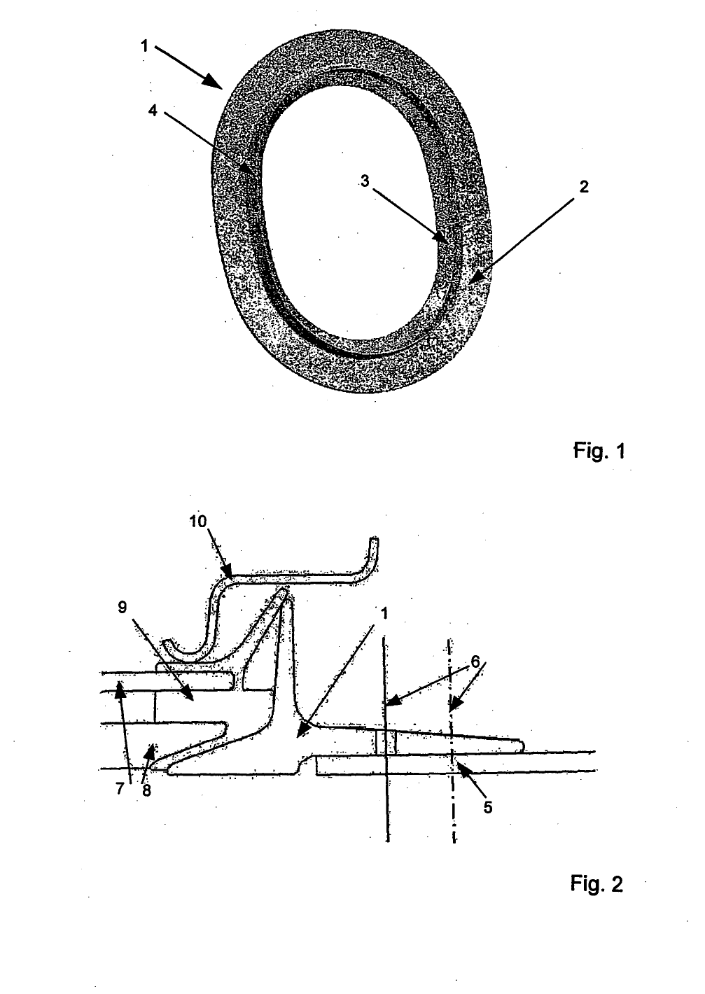

The window frame 1 shown in FIG. 1 has three different regions; specifically, these are an outer flange 2, an inner flange 31 as well as a vertical flange 4 arranged between these two flanges. FIG. 2 shows, in a detail section, the installed position of this window frame 1 in the exterior shell 5 of an aircraft Also indicated in this figure are the rivet positions 6 for the connection of the frame with the exterior shell 5, as well as two window panes 7 and 8, which together with the sealing 9 form the window element. This window element is fixed into its installation position by means of a peripheral downholder 10.

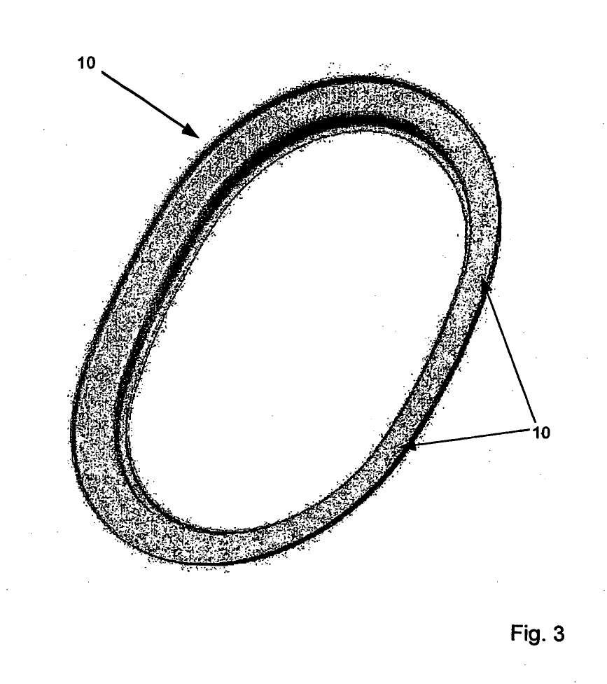

The downholder 10 is made by means of the so-called thermoplastic-deep drawing technology, in which, first, as a primary material, a semifinished part comprising reinforced web and thermoplastic in the form of a thin plate is produced, which next is deep drawn as quasi-isotropic sheet material. The downholder 10 made in this manner, which is shown in FIG. 3 in perspective view, has the same contour as a downholder made from aluminum, which also is designated as a retainer, but may have a substantially lower weight, which leads to an entire weight savings of approximately 20 percent compared to common window frames made completely from aluminum. Since the fiber-reinforced, semifinished part used as preliminary material for the manufacture is available as standard material, the manufacturing costs do not lie above those for the comparable aluminum component.

It should be noted that the term “comprising” does not exclude other elements or steps and the ‘a’ or “an” does not exclude a plurality. Also elements described in association with different embodiments may be combined.

It should also be noted that reference signs in the claims shall not be construed as limiting the scope of the claims.

1. A window frame for installation in an exterior shell of an aircraft with an aircraft structure, the window frame comprising:
an outer flange;
an inner flange;
a vertical flange;
a window element; and
a downholder;
wherein the vertical flange is arranged essentially perpendicular to the outer flange and the inner flange and between the outer flange and the inner flange;
wherein the outer flange is adapted for forming a connection of the window frame to the aircraft structure;
wherein the window element abuts against at least one of the inner flange and the vertical flange;
wherein the window element is fixed by the downholder which is connected to the window frame; and
wherein the downholder consists of a fiber-reinforced synthetic resin material and is manufactured in a deep drawing process.

2. The window frame of claim 1,
wherein the downholder comprises a layer structure; and
wherein the layer structure of the downholder corresponds to a quasi-isotropic plate.

3. A method for manufacturing a downholder for a window frame for installation in an exterior shell of an aircraft with an aircraft structure, the window frame comprising an outer flange, an inner flange, a vertical flange, a window element, and a downholder, wherein the vertical flange is arranged essentially perpendicular to the outer flange and the inner flange and between the outer flange and the inner flange, wherein the outer flange is adapted for forming a connection of the window frame to the aircraft structure, wherein the window element abuts against at least one of the inner flange and the vertical flange, and wherein the window element is fixed by the downholder which is connected to the window frame, the method comprising:
creating a semifinished part made from web and thermoplastic material as a quasi-isotropic sheet material; and
performing a deep drawing process for bringing the semifinished part into the shape of the downholder.
